(19) United States
(12) Patent Application Publication
(10) Pub. No.: US 2017/0243312 A1
(43) Pub. Date: Aug. 24, 2017

(54) SYSTEM AND METHOD FOR PROFESSIONAL DEVELOPMENT IDENTIFICATION AND RECOMMENDATION

(71) Applicant: TEACHER MATCH, LLC, Austin, TX (US)

(72) Inventors: David Smith, Chicago, IL (US); Nicholas Montgomery, Chicago, IL (US); Sarah Kremsner, Chicago, IL (US); Sean Gyll, South Jordan, UT (US); Ron Huberman, Chicago, IL (US)

(21) Appl. No.: 15/437,553

(22) Filed: Feb. 21, 2017

Related U.S. Application Data
(60) Provisional application No. 62/297,201, filed on Feb. 19, 2016.

(51) Int. Cl. G06Q 50/20; G09B 7/06; G06Q 10/10

(52) U.S. Cl. CPC G06Q 50/2057; G06Q 50/2053; G06Q 10/10; G09B 7/06

(57) ABSTRACT

A method, computer program product, and computer system for identifying, by a computing device, a user profile of a plurality of user profiles associated with a profession, wherein the user profile may be associated with a user. The user profile may be analyzed. It may be determined that the user is eligible to receive an assessment based upon, at least in part, analyzing the user profile. The assessment may be administered to the user. Answers for the assessment provided by the user may be recorded. A score for the assessment may be generated based upon, at least in part, the answers for the assessment provided by the user. A recommended course of a plurality of courses for the user to receive may be identified based upon, at least in part, the score for the assessment.

### RELATED CASES

This application claims the benefit of U.S. Provisional Application No. 62/297,201, filed on 19 Feb. 2016, the contents of which are all incorporated by reference.

### BACKGROUND

Some professions, such as teachers, may have situations where they are unable to assess areas of professional strength and weakness. For example, teaching techniques and methods may be updated periodically, and some teachers may not be aware of these updated techniques. As another example, some skills that may have been used at one time may atrophy due to non-use of those skills.

### BRIEF SUMMARY OF DISCLOSURE

In one example implementation, a method, performed by one or more computing devices, may include but is not limited to identifying, by a computing device, a user profile of a plurality of user profiles associated with a profession, wherein the user profile may be associated with a user. The user profile may be analyzed. It may be determined that the user is eligible to receive an assessment based upon, at least in part, analyzing the user profile. The assessment may be administered to the user. Answers for the assessment provided by the user may be recorded. A score for the assessment may be generated based upon, at least in part, the answers for the assessment provided by the user. A recommended course of a plurality of courses for the user to receive may be identified based upon, at least in part, the score for the assessment.

One or more of the following example features may be included. Generating the score for the assessment may include converting a raw score associated with the score to a scaled score. Converting the raw score associated with the score to the scaled score may include comparing the raw score to a lookup table. Identifying the recommended course may include comparing the score of the user to one or more scores generated from one or more assessments administered to one or more different users. Identifying the recommended course may include identifying a tag associated with the recommended course from a computer library of courses. The user may be matched with an available form of the assessment. The recommended course may be categorized into one of planning for successful outcomes, creating a learning environment, instructing, and, analyzing and adjusting.

In another example implementation, a computing system may include one or more processors and one or more memories configured to perform operations that may include but are not limited to identifying a user profile of a plurality of user profiles associated with a profession, wherein the user profile may be associated with a user. The user profile may be analyzed. It may be determined that the user is eligible to receive an assessment based upon, at least in part, analyzing the user profile. The assessment may be administered to the user. Answers for the assessment provided by the user may be recorded. A score for the assessment may be generated based upon, at least in part, the answers for the assessment provided by the user. A recommended course of a plurality of courses for the user to receive may be identified based upon, at least in part, the score for the assessment.

One or more of the following example features may be included. Generating the score for the assessment may include converting a raw score associated with the score to a scaled score. Converting the raw score associated with the score to the scaled score may include comparing the raw score to a lookup table. Identifying the recommended course may include comparing the score of the user to one or more scores generated from one or more assessments administered to one or more different users. Identifying the recommended course may include identifying a tag associated with the recommended course from a computer library of courses. The user may be matched with an available form of the assessment. The recommended course may be categorized into one of planning for successful outcomes, creating a learning environment, instructing, and, analyzing and adjusting.

In another example implementation, a computer program product may reside on a computer readable storage medium having a plurality of instructions stored thereon which, when executed across one or more processors, may cause at least a portion of the one or more processors to perform operations that may include but are not limited to identifying a user profile of a plurality of user profiles associated with a profession, wherein the user profile may be associated with a user. The user profile may be analyzed. It may be determined that the user is eligible to receive an assessment based upon, at least in part, analyzing the user profile. The assessment may be administered to the user. Answers for the assessment provided by the user may be recorded. A score for the assessment may be generated based upon, at least in part, the answers for the assessment provided by the user. A recommended course of a plurality of courses for the user to receive may be identified based upon, at least in part, the score for the assessment.

One or more of the following example features may be included. Generating the score for the assessment may include converting a raw score associated with the score to a scaled score. Converting the raw score associated with the score to the scaled score may include comparing the raw score to a lookup table. Identifying the recommended course may include comparing the score of the user to one or more scores generated from one or more assessments administered to one or more different users. Identifying the recommended course may include identifying a tag associated with the recommended course from a computer library of courses. The user may be matched with an available form of the assessment. The recommended course may be categorized into one of planning for successful outcomes, creating a learning environment, instructing, and, analyzing and adjusting.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a development process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a development process according to one or more example implementations of the disclosure; and

FIG. 4 is an example conceptual diagram of a development process according to one or more example implementations of the disclosure.

Like reference symbols in the various drawings indicate like elements.

### DETAILED DESCRIPTION

### System Overview

Some professions, such as teachers, may have situations where they are unable to assess areas of professional strength and weakness. For example, teaching techniques and methods may be updated periodically, and some teachers may not be aware of these updated techniques. As another example, some skills that may have been used at one time may atrophy due to non-use of those skills. As will be discussed in greater detail below, development process 10 may enable a teacher (or other profession) to assess areas of professional strength and weakness and generate recommendations on specific coursework the teachers may need to take to improve their skills.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

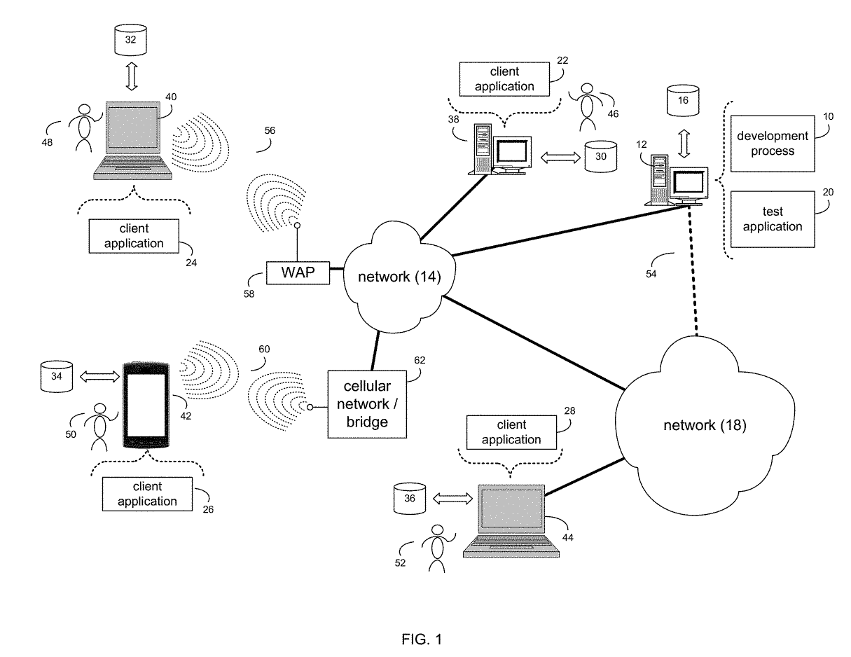

Referring now to the example implementation of FIG. 1, there is shown development process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a development process, such as development process 10 of FIG. 1, may identify a user profile of a plurality of user profiles associated with a profession, wherein the user profile may be associated with a user. The user profile may be analyzed. It may be determined that the user is eligible to receive an assessment based upon, at least in part, analyzing the user profile. The assessment may be administered to the user. Answers for the assessment provided by the user may be recorded. A score for the assessment may be generated based upon, at least in part, the answers for the assessment provided by the user. A recommended course of a plurality of courses for the user to receive may be identified based upon, at least in part, the score for the assessment.

In some implementations, the instruction sets and subroutines of development process 10, which may be stored on storage device, such as storage device 16, coupled to computer 12, may be executed by one or more processors (not shown) and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, development process 10 may be a component of the data store, a standalone application that interfaces with the above noted data store and/or an applet / application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a test application (e.g., test application 20), examples of which may include but are not limited to a test administration application, a test answer recording application, a professional development opportunity and recommendation system, such as the TeacherMatch® Thrive™ application provided by TeacherMatch® of Chicago, Ill., or other application that allows for the taking tests, administering tests, and analysis of test results. In some implementations, development process 10 and/or test application 20 may be accessed via one or more of client applications 22, 24, 26, 28. In some implementations, development process 10 may be a standalone application, or may be an applet/application/script/extension that may interact with and/or be executed within test application 20, a component of test application 20, and/or one or more of client applications 22, 24, 26, 28. In some implementations, test application 20 may be a standalone application, or may be an applet/application/script/extension that may interact with and/or be executed within development process 10, a component of development process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of development process 10 and/or test application 20. Examples of client applications 22, 24, 26, 28 may include, but are not limited to, e.g., a test administration application, a test answer recording application, a professional development opportunity and recommendation system, such as the TeacherMatch® Thrive™ application provided by TeacherMatch® of Chicago, Ill., or other application that allows for the taking tests, administering tests, and analysis of test results, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

In some implementations, one or more of client applications 22, 24, 26, 28 may be configured to effectuate some or all of the functionality of development process 10 (and vice versa). Accordingly, in some implementations, development process 10 may be a purely server-side application, a purely client-side application, or a hybrid server-side/client-side application that is cooperatively executed by one or more of client applications 22, 24, 26, 28 and/or development process 10.

In some implementations, one or more of client applications 22, 24, 26, 28 may be configured to effectuate some or all of the functionality of test application 20 (and vice versa). Accordingly, in some implementations, test application 20 may be a purely server-side application, a purely client-side application, or a hybrid server-side/client-side application that is cooperatively executed by one or more of client applications 22, 24, 26, 28 and/or test application 20. As one or more of client applications 22, 24, 26, 28, development process 10, and test application 20, taken singly or in any combination, may effectuate some or all of the same functionality, any description of effectuating such functionality via one or more of client applications 22, 24, 26, 28, development process 10, test application 20, or combination thereof, and any described interaction(s) between one or more of client applications 22, 24, 26, 28, development process 10, test application 20, or combination thereof to effectuate such functionality, should be taken as an example only and not to limit the scope of the disclosure.

In some implementations, one or more of users 46, 48, 50, 52 may access computer 12 and development process 10 (e.g., using one or more of client electronic devices 38, 40, 42, 44) directly through network 14 or through secondary network 18. Further, computer 12 may be connected to network 14 through secondary network 18, as illustrated with phantom link line 54. Development process 10 may include one or more user interfaces, such as browsers and textual or graphical user interfaces, through which users 46, 48, 50, 52 may access development process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

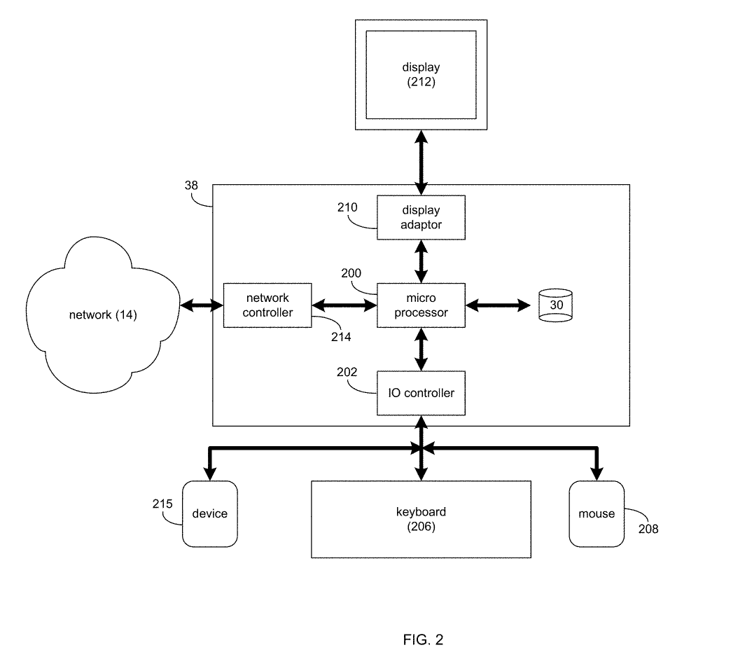

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, development process 10 may be substituted for client electronic device 38 (in whole or in part) within FIG. 2, examples of which may include but are not limited to computer 12 and/or one or more of client electronic devices 38, 40, 42, 44.

In some implementations, client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports (not shown), and printer ports (not shown). A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

As will be discussed below, development process 10 may at least help, e.g., improve existing technological processes associated with, e.g., predictive analytics for determining areas of professional strength and weakness necessarily rooted in computer technology in order to overcome problems specifically arising in the realm of computer networks utilizing online predictive analytics for determining areas of professional strength and weakness.

### The Development Process

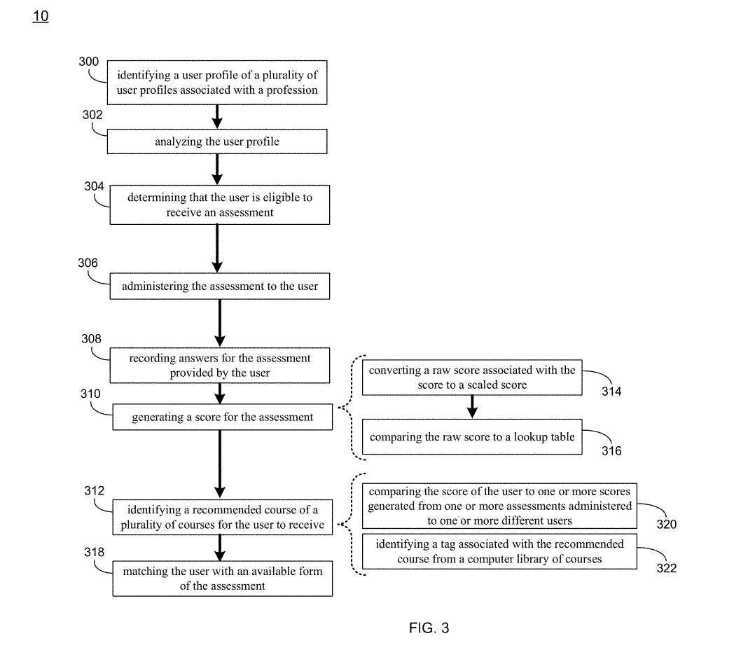

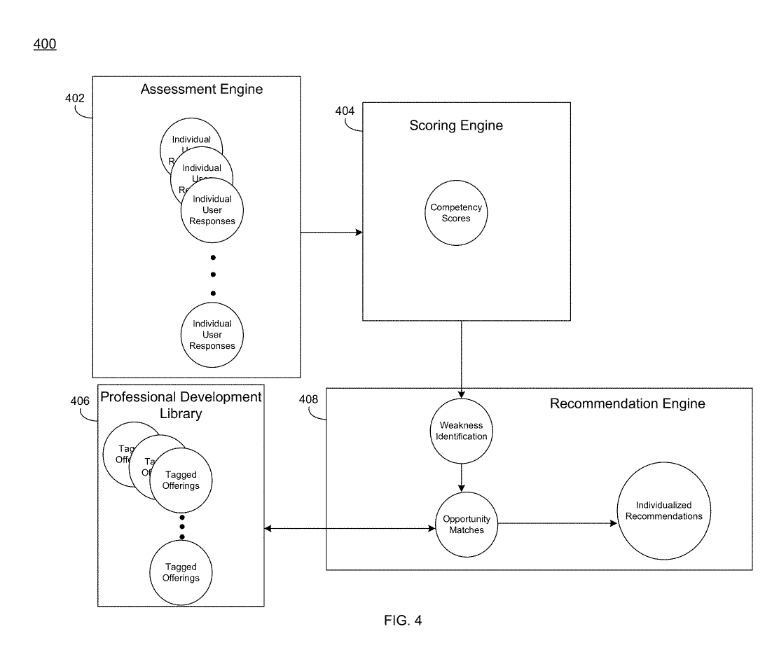

As discussed above and referring also at least to the example implementations of FIGS. 3-4, development process 10 may identify 300 a user profile of a plurality of user profiles associated with a profession, wherein the user profile may be associated with a user. Development process 10 may analyze 302 the user profile. Development process 10 may determine 304 that the user is eligible to receive an assessment based upon, at least in part, analyzing the user profile. Development process 10 may administer 306 the assessment to the user. Development process 10 may record 308 answers for the assessment provided by the user. Development process 10 may generate 310 a score for the assessment based upon, at least in part, the answers for the assessment provided by the user. Development process 10 may identify 312 a recommended course of a plurality of courses for the user to receive based upon, at least in part, the score for the assessment.

For simplicity, the present disclosure is described using teachers as the profession; however, it will be appreciated that any other profession may be used without departing from the scope of the disclosure. As such, the description of a teacher should be used as an example only and not to otherwise limit the scope of the disclosure.

In some implementations, and referring at least to example FIG. 4, an example conceptual diagram 400 of one or more aspects of development process 10 is shown. In the example, development process 10 may include and/or access, e.g., an assessment engine 402, a scoring engine 404, a professional development library 406, and a recommendation engine 408, each of which will be described in greater detail below.

In some implementations, development process 10 may identify 300 a user profile of a plurality of user profiles associated with a profession, wherein the user profile may be associated with a user. For example, electronic assessment engine 402 of development process 10 may maintain (e.g., in a data store) a bank of user profiles. For instance, assume for example purposes only that user 46 (e.g., Teacher X) has set up a teacher based user profile. In some implementations, the user profile may include, e.g., the name of the teacher, past work experience/locations where Teacher X has previously taught, a current location (e.g., geographic location, school district, particular school, etc.) where Teacher X is currently employed, subject areas of expertise (e.g., math, social studies, special education, etc.), position of employment (e.g., 10^{th} grade mathematics teacher, elementary general teacher, etc.), education level, university attended, professional certifications, job preferences, etc.

In some implementations, development process 10 may identify 300 the above-noted user profile of Teacher X. For example, the user profile may be identified 300 at random, or the user profile may be identified 300 based upon a predetermined period of time since the user profile of Teacher X has been analyzed. It will be appreciated that other techniques to identify 300 the user profile may be used without departing from the scope of the disclosure.

In some implementations, development process 10 may analyze 302 the user profile and may determine 304 that the user is eligible to receive an assessment based upon, at least in part, analyzing 302 the user profile. For example, to allow users to complete an assessment, electronic assessment engine 402 of development process 10 may analyze 302 user profiles, such as the user profile of Teacher X, and may determine 304 which users are eligible or require assessment. For example, typically, development process 10 may analyze 302 user profiles and determine 304 that the user is eligible to receive an assessment by identifying, for instance, all users that are in eligible positions, e.g., within a school district, at the time of initial implementation, new instructional employees hired into a district, and instructors whose prior results have expired. Development process 10 may set the position eligibility and/or may default to instructional positions. Development process 10 may set the expiration timeframe and/or may default to 1 year or other length of time.

In some implementations, development process 10 may match 318 the user with an available form of the assessment. For example, the individuals, such as Teacher X, may be matched 318 with an available form of the assessment by development process 10. For instance, development process 10 may associate specific position types (such as the above-noted position types) to specific types of assessments. In some implementations, development process 10 may initially assume that instructional positions are matched to instructional assessments. In some implementations, the specific form of the assessment within the assessment type may be chosen at random by development process 10. In some implementations, if multiple forms are available for a particular individual, the form administered by development process 10 may be randomly selected by development process 10.

In some implementations, development process 10 may administer 306 the assessment to the user and may record 308 answers for the assessment provided by the user. For example, development process 10 may electronically invite and administer 306 the assessment to Teacher X and record the answers provided by Teacher X for later analysis. In some implementations, the invitation may be sent via email, text message, or other known technique.

In some implementations, the assessment may include a plurality of survey questions selected by development process 10. For example, development process 10 may maintain a bank of survey questions. In some implementations, the questions may be multiple choice question. The questions administered on a given form of assessment may be chosen from a bank of preselected eligible questions. In some implementations, each section of the assessment corresponding to an assessment domain may sample (via development process 10) a predetermined number of items from the bank of eligible questions. In some implementations, the survey questions, which may have been rigorously tested for their association with specific skills and competencies, may be psychometrically tuned to measure competencies. The questions may be grouped into multiple equivalent forms, allowing for a specific individual to take different forms of the assessment at each administration without completing exactly the same items (e.g., questions) while maintaining equivalent meaning in the scores. Similarly, separate individuals may complete different forms of the assessment while still maintaining form equivalence. In some implementations, the items may be entirely preselected (e.g., via development process 10) and the form may be chosen at random (e.g., via development process 10) from multiple possible forms. In some implementations, item characteristics may be used (e.g., via development process 10) to determine the items selected. Item characteristics may include the domain assessed (e.g., planning skills vs classroom management) as well as the difficulty of the item corresponding to that scale (e.g., Rasch item measure difficulty). Items may be selected (e.g., via development process 10) to ensure an equal number of items are selected per domain and that the difficulty rating for each domain averages to the overall mean of available item difficulties (e.g., within a threshold T, typically 0.1)

In some implementations, development process 10 may generate 310 a score for the assessment based upon, at least in part, the answers for the assessment provided by the user. In some implementations, generating 310 the score for the assessment may include development process 10 converting 314 a raw score associated with the score to a scaled score. For instance, assume for example purposes only that 100 multiple choice questions were administered by development process 10. Further assume that 70 questions were answered correctly by Teacher X. In the example, the above-noted scoring engine 404 of development process 10 may generate 310 a score (e.g., a raw score) of 70/100, which may be converted 314 to a scaled score. In some implementations, converting 314 the raw score associated with the score to the scaled score may include development process 10 comparing 316 the raw score to a lookup table. For instance, in some implementations, development process 10 may take results from each individual's question responses, and the particular form of the assessment administered, and may generate 310 comparable scores on each competency category. That is, having different items administered with different difficulties, may result in raw scores that may have different meanings. The lookup table may allow for multiple forms of the assessment, and different banks of questions with varying difficulties, to be used across time and individuals while still leading to scales on the same scale and holding the same meaning. These competency score results may be stored (e.g., in the above-noted data store) for later analysis and may be passed to recommendation engine 408 of development process 10. The above-noted raw scores (e.g., the number of correct responses within a competency) may be converted 314 into scale scores for each individual by comparing 316 the scale scores to a previously defined lookup table. For example, the raw score may be converted 314 to a scaled score by either using a lookup table that is pre-calculated for the administered form or by converting the score using an algorithm defined based on parameters of the items administered. In the case of the lookup table, each possible score on the assessment may have a predetermined lookup table. The raw score received by the user, e.g., 32, may have a corresponding scale score value (e.g., 73). To convert the score based on item characteristics, a number of example procedures may be used. For example, development process 10 may apply a normalization technique (e.g., subtracting the overall sample mean of other respondents completing the form, dividing by the standard deviation of that sample, multiplying by 10 and adding 50). Another example conversion 314 may first calculate an intermediate scale score and then normalize using the aforementioned technique. One potential intermediate scale score calculation may follow the standard Rasch analysis approach.

In the example case of converting 314 the score based on item characteristics, the results may be stored or cached (e.g., via development process 10) in a lookup table for future use without having to recalculate the score.

In some implementations, development process 10 may identify 312 a recommended course of a plurality of courses for the user to receive based upon, at least in part, the score for the assessment. For example, recommendation engine 408 of development process 10 may take the score (e.g., the competency score) from the above-noted scoring engine for individuals and may identify 312 strength areas and areas where the individual may improve, which may correspond to a particular recommended course that the individual (e.g., Teacher X) should take to improve the deficient skill. Each of the identified opportunities may be prioritized to focused on the area of greatest opportunity for improvement for the individual.

For example, in some implementations, the identified 312 recommended course may be categorized by development process 10 into one of planning for successful outcomes, creating a learning environment, instructing, and, analyzing and adjusting. It will be appreciated that the above-noted recommended courses are examples, and that other categories and recommended courses may be used without departing from the scope of the disclosure.

In some implementations, identifying 312 the recommended course may include development process 10 comparing 320 the score of the user to one or more scores generated from one or more assessments administered to one or more different users. For instance, assume for example purposes only that Teacher X had a scaled score on competency A of, e.g., 50 whereas the mean for other users on the same competency was, e.g., 60. This may indicate this was an area weaker for Teacher X compared to other individuals. If Teacher X also had a scaled score of, e.g., 50 on competency B while other users had a mean of, e.g., 52, this may indicate that competency A is relatively weaker for Teacher X than competency B. This may cause development process 10 to identify 312 courses that target competency A should be recommended by development process 10 to Teacher X.

In some implementations, identifying 312 the recommended course may include development process 10 identifying 322 a tag associated with the recommended course from a computer library of courses. For example, development process 10 may search the above-noted professional development library 406 (which may be included in the above-noted data store) for the identified courses most likely to improve outcomes for that individual. For example, online and in person professional development offerings may be stored in an online registry (e.g., in the data store) for each employer (e.g., employer of Teacher X or other employers). Each offering within professional development library 406 may be identified 322 by a tag to the specific competencies targeted by the assessments. For example, given a Course A and a Course B, the former tagged with competency A and the latter tagged with competency B, users flagged as weak in competency A may be recommended Course A and users flagged as weak in Competency B would be recommended Course B. In the example case where Course C may be tagged with multiple competencies, users with weaknesses in either competency (as denoted by the assessments) may be recommended to take Course C by development process 10. In some implementations, those offerings may be electronically presented to Teacher X through, e.g., an intuitive web interface. In some implementations, by having Teacher X take the recommended offering, Teacher X may improve his/her skills in that particular area noted as being an area of possible deficiency.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, a user profile of a plurality of user profiles associated with a profession, wherein the user profile is associated with a user;
analyzing the user profile;
determining that the user is eligible to receive an assessment based upon, at least in part, analyzing the user profile;
administering the assessment to the user;
recording answers for the assessment provided by the user;
generating a score for the assessment based upon, at least in part, the answers for the assessment provided by the user; and
identifying a recommended course of a plurality of courses for the user to receive based upon, at least in part, the score for the assessment.

2. The computer-implemented method of claim 1 wherein generating the score for the assessment includes converting a raw score associated with the score to a scaled score.

3. The computer-implemented method of claim 2 wherein converting the raw score associated with the score to the scaled score includes comparing the raw score to a lookup table.

4. The computer-implemented method of claim 1 wherein identifying the recommended course includes comparing the score of the user to one or more scores generated from one or more assessments administered to one or more different users.

5. The computer-implemented method of claim 1 wherein identifying the recommended course includes identifying a tag associated with the recommended course from a computer library of courses.

6. The computer-implemented method of claim 1 further comprising matching the user with an available form of the assessment.

7. The computer-implemented method of claim 1 wherein the recommended course is categorized into one of planning for successful outcomes, creating a learning environment, instructing, and, analyzing and adjusting.

8. A computer program product residing on a computer readable storage medium having a plurality of instructions stored thereon which, when executed across one or more processors, causes at least a portion of the one or more processors to perform operations comprising:
identifying a user profile of a plurality of user profiles associated with a profession, wherein the user profile is associated with a user;
analyzing the user profile;
determining that the user is eligible to receive an assessment based upon, at least in part, analyzing the user profile;
administering the assessment to the user;
recording answers for the assessment provided by the user;
generating a score for the assessment based upon, at least in part, the answers for the assessment provided by the user; and
identifying a recommended course of a plurality of courses for the user to receive based upon, at least in part, the score for the assessment.

9. The computer program product of claim 8 wherein generating the score for the assessment includes converting a raw score associated with the score to a scaled score.

10. The computer program product of claim 9 wherein converting the raw score associated with the score to the scaled score includes comparing the raw score to a lookup table.

11. The computer program product of claim 8 wherein identifying the recommended course includes comparing the score of the user to one or more scores generated from one or more assessments administered to one or more different users.

12. The computer program product of claim 8 wherein identifying the recommended course includes identifying a tag associated with the recommended course from a computer library of courses.

13. The computer program product of claim 8 further comprising matching the user with an available form of the assessment.

14. The computer program product of claim 8 wherein the recommended course is categorized into one of planning for successful outcomes, creating a learning environment, instructing, and, analyzing and adjusting.

15. A computing system including one or more processors and one or more memories configured to perform operations comprising:
identifying a user profile of a plurality of user profiles associated with a profession, wherein the user profile is associated with a user;
analyzing the user profile;
determining that the user is eligible to receive an assessment based upon, at least in part, analyzing the user profile;
administering the assessment to the user;
recording answers for the assessment provided by the user;
generating a score for the assessment based upon, at least in part, the answers for the assessment provided by the user; and
identifying a recommended course of a plurality of courses for the user to receive based upon, at least in part, the score for the assessment.

16. The computing system of claim 15 wherein generating the score for the assessment includes converting a raw score associated with the score to a scaled score.

17. The computing system of claim 16 wherein converting the raw score associated with the score to the scaled score includes comparing the raw score to a lookup table.

18. The computing system of claim 15 wherein identifying the recommended course includes comparing the score of the user to one or more scores generated from one or more assessments administered to one or more different users.

19. The computing system of claim 15 wherein identifying the recommended course includes identifying a tag associated with the recommended course from a computer library of courses.

20. The computing system of claim 15 further comprising matching the user with an available form of the assessment.

21. The computing system of claim 15 wherein the recommended course is categorized into one of planning for successful outcomes, creating a learning environment, instructing, and, analyzing and adjusting.
